(19) United States
(12) Patent Application Publication
(10) Pub. No.: US 2002/0185215 A1
(43) Pub. Date: Dec. 12, 2002

(54) System and process for manufacturing fastening mechanisms which connect articles and the like together

(76) Inventor: Kim A. Ortiz, Denver, CO (US)

Correspondence Address: Emery L. Tracy, P.O. Box 1518, Boulder, CO, 80306-1518, US

(21) Appl. No.: 10/137,674

(22) Filed: May 2, 2002

Related U.S. Application Data
(60) Provisional application No. 60/288,836, filed on May 4, 2001.

(51) Int. Cl. B29C 47/00

(52) U.S. Cl. 156/245; 156/289; 156/500

(57) ABSTRACT

An injection molding system for producing a fastening mechanism having a connecting element and an attachment portion is provided. The injection molding system comprises an injection molding tool. At least one cavity is formed in the injection molding tool for molding a male/female connecting element. At least one void is formed in the injection molding tool for receiving an insert for molding the attachment portion with the insert aligned with the cavity of the male/female connecting element and the combined male/female connecting element and attachment portion forming the fastening mechanism. A mechanism releasably secures the insert within the void wherein the insert is interchangeable with other inserts allowing various attachment portions for the male/female connecting element.

The present application is a continuation of pending provisional patent application Serial No. 60/288,836, filed on May 4, 2001, entitled “Manufacturing Process for Fastening Mechanism for Connecting Articles and the Like Together”.

### BACKGROUND OF THE INVENTION

1. Field of the Invention

This invention relates generally to a system and process for manufacturing fastening mechanisms and, more particularly, the invention relates to a system and process for manufacturing male/female fastening mechanisms using interchangeable inserts to reduce operation costs and increase the variety of fastening mechanisms.

2. Description of the Prior Art

Fastening mechanisms are known for releasably closing various articles including, but not limited to, backpacks, brief bags, camping equipment, etc. Typically, the process to produce the conventional fastening mechanism consists of a metallic mold constructed from two or more working parts that embodies the machined voids of a conventional fastening mechanism consisting of one or more working elements. Since the vast majority of fastening mechanisms on the market consists of a male element that connects to a female element, to produce the male and female units effectively, a manufactured tool of each unit design must be machined to produce a quality product and eliminate sorting. If another size fastener is to be manufactured, an additional two injection molding tools are necessary to manufacture both the male and female element of that fastening mechanism. If four fastening mechanisms are to be produced, eight injection molding tools will need to be produced.

Accordingly, there exists a need for a system and process which reduces the needed amount of raw materials, both metals and plastics, thereby reducing production costs of the fastening mechanisms. It is necessary that each fastening mechanism embody both the male and female elements of each unit of the fastening mechanism, staying consistent in size. In addition, each designed connector element will have machined insert or inserts that will be placed in the cavity or cavities for the connecting elements at one end thereof the fastening mechanism. These unique connecting elements can then be inserted or removed from the tool that houses the void of the fastening mechanism with no need to manufacture another injection molding tool. The system and process of the present invention reduces the use of raw materials, tooling, and manufacturing costs by at least two-thirds and will increase the number of fastening mechanism combinations offering versatility to the consumer.

### SUMMARY

The present invention is an injection molding system for producing a fastening mechanism having a connecting element and an attachment portion is provided. The injection molding system comprises an injection molding tool. At least one cavity is formed in the injection molding tool for molding a male/female connecting element. At least one void is formed in the injection molding tool for receiving an insert for molding the attachment portion with the insert aligned with the cavity of the male/female connecting element and the combined male/female connecting element and attachment portion forming the fastening mechanism. A mechanism releasably secures the insert within the void wherein the insert is interchangeable with other inserts allowing various attachment portions for the male/female connecting element.

Additionally, the present invention includes a tool for forming a fastening mechanism. Each fastening mechanism has both a male portion and a female portion for mating with another identical fastening mechanism. Each fastening mechanism further has an attachment portion. The tool comprises a molding plate and a first voided area formed in the molding plate with the first voided area being configured to the shape of the fastening mechanism. A first cavity is formed in the molding plate adjacent the first voided area. A first insert is releasably securable within the first cavity with the first insert being configured to the shape of the attachment portion.

The present invention further includes a method for constructing a first fastening mechanism and a second fastening mechanism. The first fastening mechanism is identical to the second fastening mechanism with both the first fastening mechanism and the second fastening mechanism having a connecting element and an attachment portion. The method comprises providing an injection molding tool, forming a first cavity in the injection molding tool for molding the first connecting element, forming a first void in the injection molding tool adjacent the first cavity for receiving a first insert for molding the first attachment portion, the first insert aligned with the first cavity, releasably securing the first insert within the first void, and injecting a molding substance into the injection molding tool.

### BRIEF DESCRIPTION OF THE DRAWINGS

FIG. 1 is a perspective view illustrating a first fastening mechanism releasably secured to a second fastening mechanism with the first fastening mechanism and the second fastening mechanism being constructed from the system and process of the present invention;

FIG. 2 is a perspective view illustrating the tooling system and process of the present invention with a first fastening mechanism and an identical second fastening mechanism;

FIG. 3 is a perspective view illustrating the tooling system and process of the present invention with a first fastening mechanism and an identical second fastening mechanism;

FIG. 4 is an exploded view illustrating another embodiment of the identical fastening mechanism for releasably securing articles and the like together, constructed in accordance with the present invention;

FIG. 5 is a perspective view illustrating the tooling system and process for the embodiment of the fastening mechanism of FIG. 4, constructed in accordance with the present invention;

FIG. 6 is a perspective view illustrating the tooling system and process for another embodiment of the fastening mechanism, constructed in accordance with the present invention;

FIGS. 7a-7i are a front views illustrating unique connector elements and attachment portions at one end thereof of the fastening mechanism;

FIGS. 8a-8c are various views illustrating unique connector elements and attachment portions at one end thereof of the fastening mechanism;

FIGS. 9a-9c are various views illustrating unique connector elements and attachment portions at one end thereof of the fastening mechanism; and

FIGS. 10a-10d are front views illustrating unique connector elements and attachment portion at one end thereof of the fastening mechanism.

### DETAILED DESCRIPTION OF THE PREFERRED EMBODIMENTS

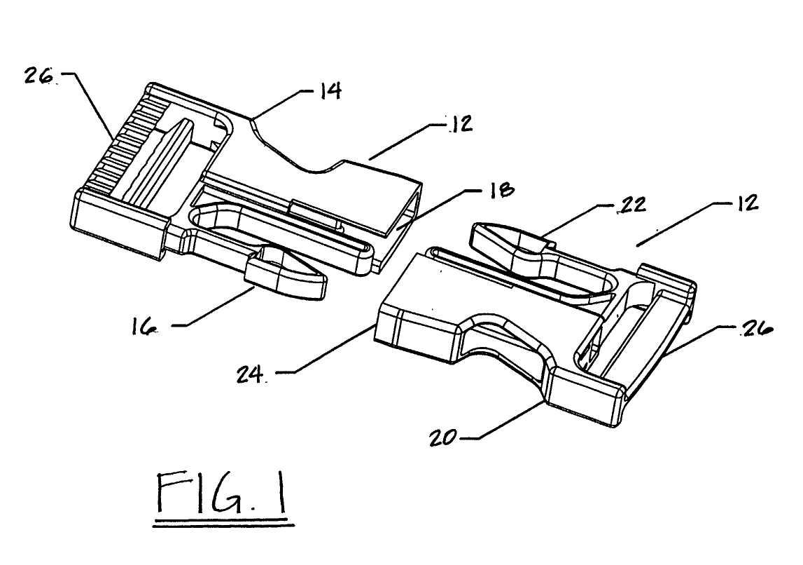

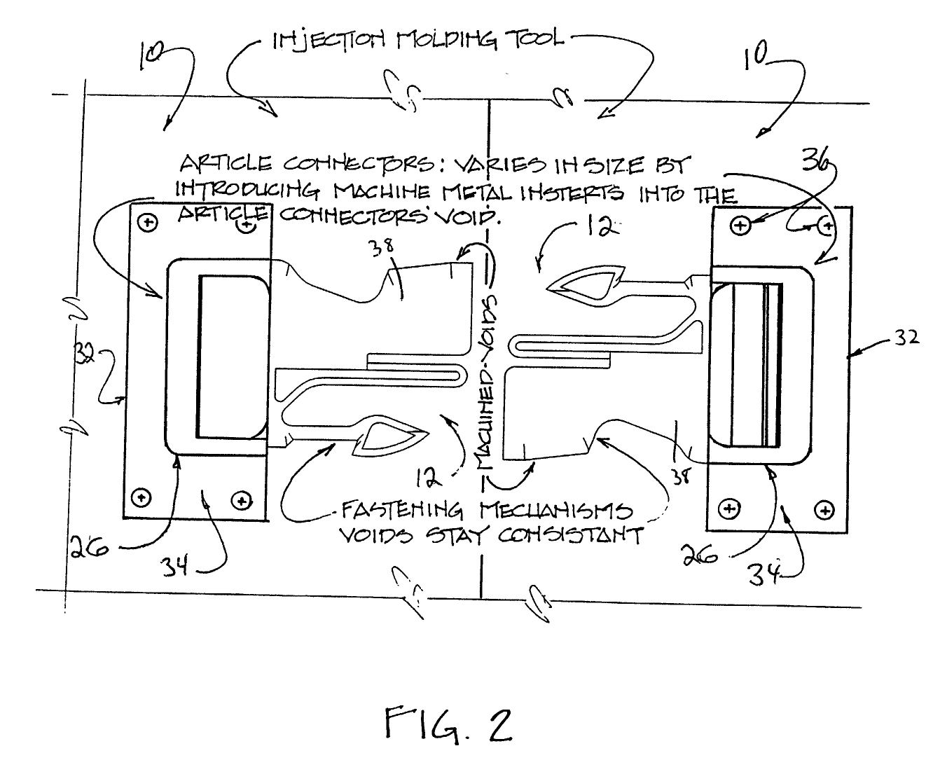

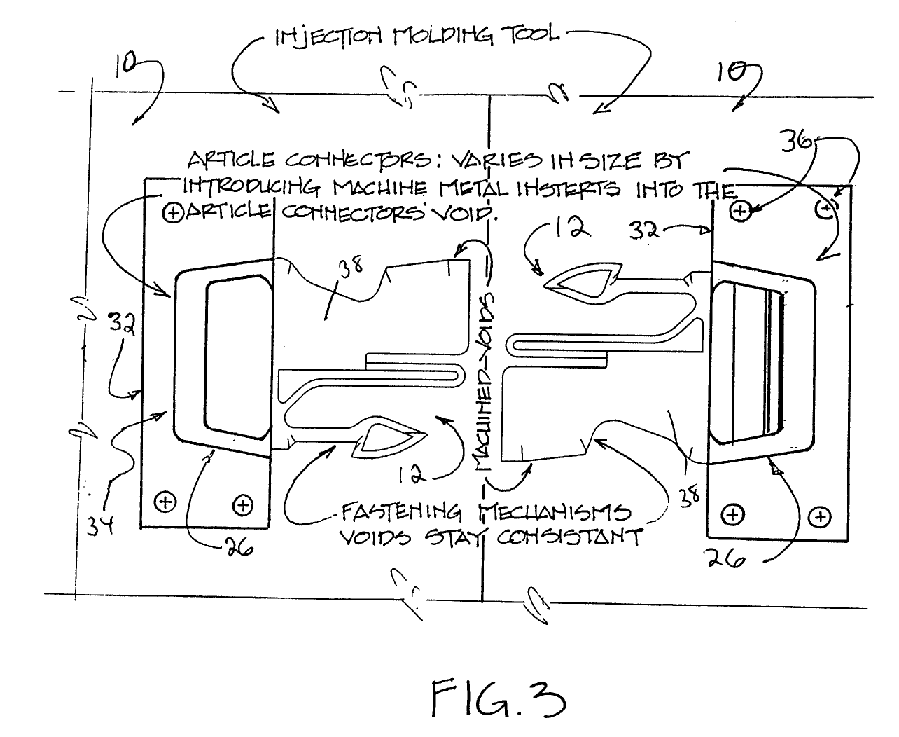

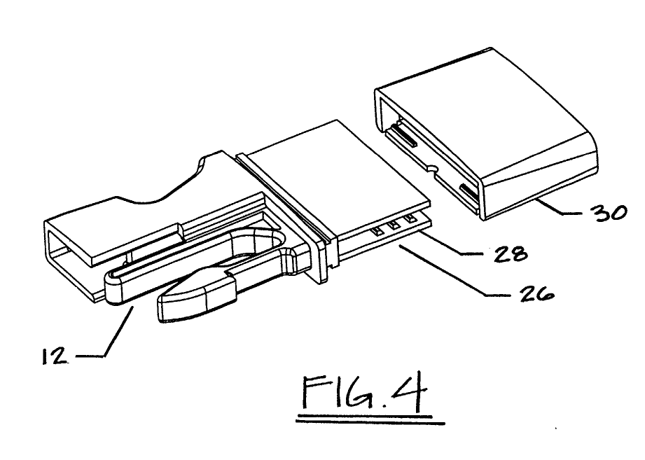

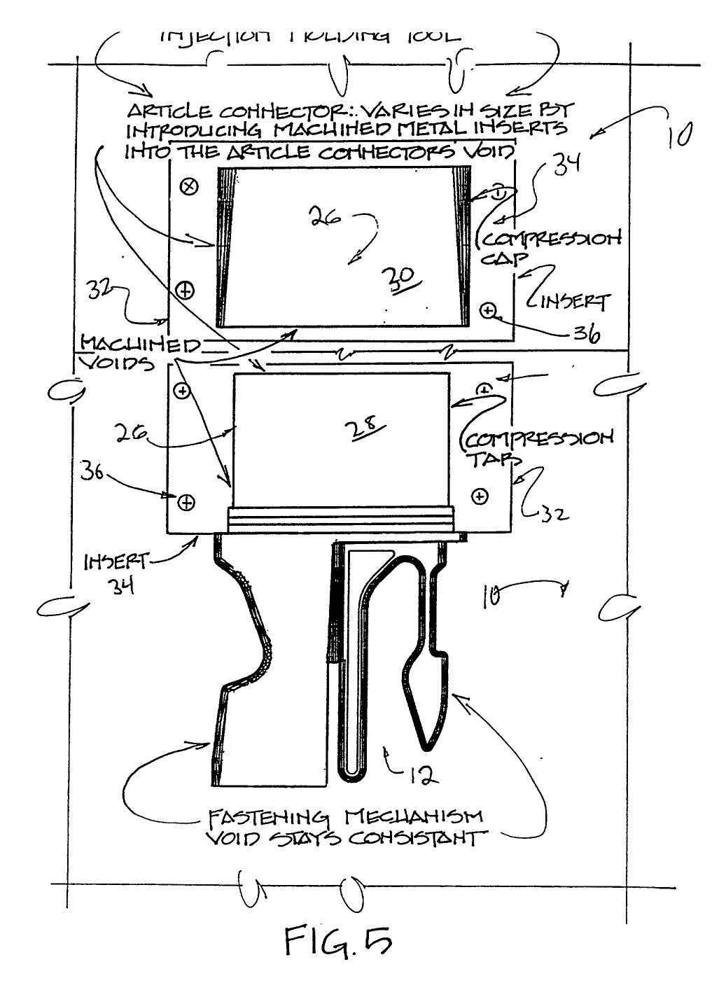

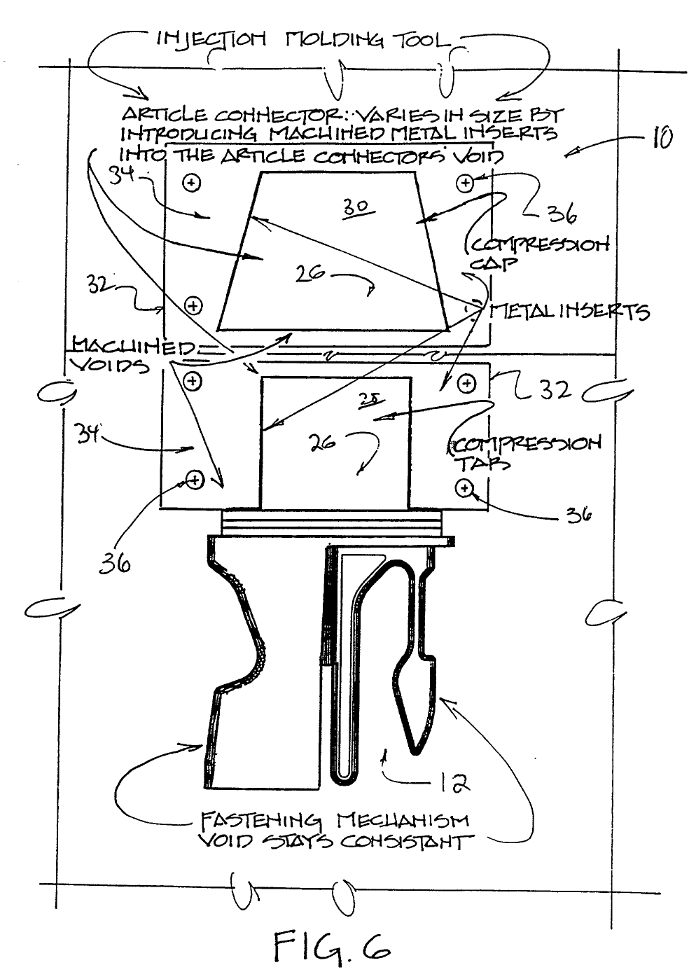

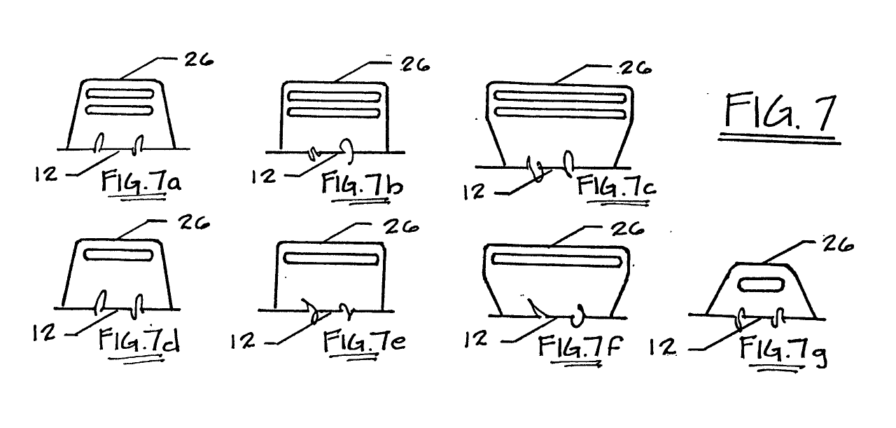

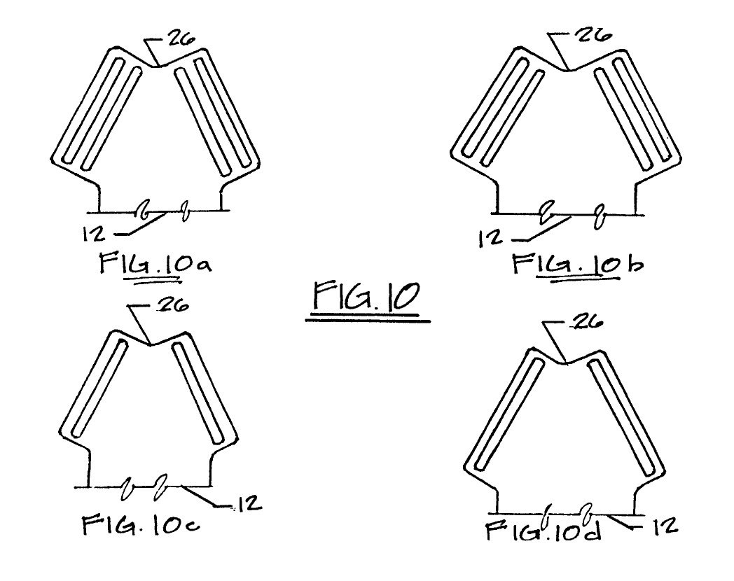

As illustrated in FIGS. 1-10, the present invention is an injection tool 10 for a system and process for manufacturing a pair of identical fastening mechanisms 12 which connects articles (not shown) and the like together. The fastening mechanisms 12 releasably connect a first article and a second article together and comprises a first connecting element 14 secured to the first article with the first connecting element 14 having a first male portion 16 and a first female portion 18. A second connecting element 20 is secured to the second article with the second connecting element 20 having second male portion 22 and a second female portion 24.

In operation, the first male portion 16 of the first connecting element 14 matingly connects with the second female portion 24 of the second connecting element 20 and the second male portion 22 of the second connecting 20 element matingly connects with the first female portion 18 of the first connecting element 14 wherein the first connecting element 14 releasably connects to the second connecting element 20 thereby releasably connecting the first article to the second article. While the fastening mechanism 12 of the present invention is described for particular use with a strap (not shown) and the like, it should be noted that the fastening mechanism 12 of the present invention can be used on any type of article and not intended to limited for use only on straps.

Each of the connecting elements 14, 20 has an attachment portion 26 at one end thereof. As illustrated in FIGS. 1-10, the attachment portion 26 can be formed in several forms for receiving a strap or the like. In addition, some forms of the attachment portion 26 can be suited for attachment of the fastening mechanism 12 to clothing, shoes, luggage, backpacks, containers, etc., without the fastening mechanism 12 first being attached to a strap or the like.

FIGS. 4-6 illustrates other embodiments of the fastening mechanism 12 for releasably securing a strap and a fastening mechanism 12 together, constructed in accordance with the present invention. The attachment portions 26 of these embodiments include compression tabs 28 receivable within a compression cap 30. The compression cap 28 compresses together the compression tab 30 to maintain the strap or the like within the attachment portion 26.

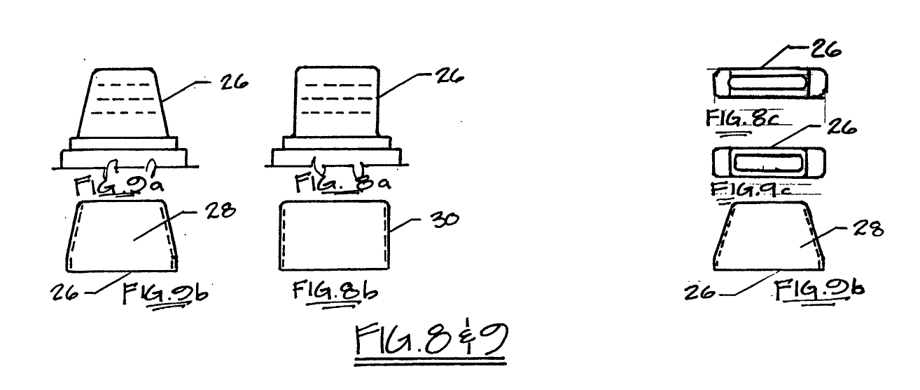

FIGS. 2, 3, 5, and 6 illustrate the injection tool 10 of the present invention used to produce the fastening mechanism 12, including the connecting element 14, 16 and the attachment portion 26 at one end of the connecting element 14, 16. The fastening mechanism 12 is preferably formed within the injection tool 10 through an injection molding process.

The injection tool 10 of the present invention is preferably constructed from aluminum, steel, or various metal alloys, etc. Furthermore, the injection tool 10 is usually constructed from two or more working units. One (1) to sixteen (16) identical voids of the fastening mechanism 12 are machined into the working units of the tool 10 for heated materials such as plastic or other formable material to be extruded and or injected into the void or voids 38 formed in the injection tool 10. The void or voids 38 are sized and shaped in the form of the fastening mechanism 12. It should be noted that while the injection tool 10 and the fastening mechanisms 12 of present invention have been described as being constructed from metal and plastic, respectively, it is within the scope of the present invention to construct the injection tool 10 and the fastening mechanisms 12 from other materials.

To produce the attachment portion 26 at one end of the connecting element 14, 20, a voided cavity or cavities 32 is machined into the injection tool 10 adjacent the void or voids 38 of the fastening mechanism 12. The cavity or cavities 32 are sized and shaped to receive metal insert or inserts 34 in the form of the desired attachment portion 26. The insert or inserts 34 are positioned in the cavity or cavities 32 and placed into position with screws, bolts 36, loose-fit, press-fit, etc. or the like thereby releasably placing the insert or inserts 34 that embodies the voided desired design of the connector element 26 at one end thereof the fastening mechanism 12. Any type of positioning of the insert or inserts 34 into the cavity or cavities 32 as typically known in the art is within the scope of the present invention. The insert or inserts 34 can be removed from the tool 10 and the replaced with another attachment portion 16 design insert or inserts 34 thereby allowing many different types of fastening mechanisms 12 while eliminating the manufacturing of additional injection molding tools 10.

It should be noted that the embodiments of FIGS. 5 and 6 include an additional cavity 32 for receiving an insert 34 for the compression cap 30. The additional cavity 32 can be formed adjacent the cavity 32 for the compression tab 28. The compression cap insert 34 is releasably secured within the additional cavity 32 with screws or the like.

As understood by a person skilled in the art, the fastening mechanism 12 is formed through an injection molding process. Once the appropriate attachment portion 26 insert 34 has been releasably secured within the cavity 32, the molding material is inserted into the void 38 and the insert 34 to form the fastening mechanism 12. Molding with the injection tool 10 of the present invention can be accomplished with A/B sides of the injection tool 10 with side A and side B being complimentary to each other to form the fastening mechanism 12. Other injection molding techniques are also within the scope of the present invention.

The system and process of the present invention to produce a fastening mechanism 12 for releasably securing a strap and fastening mechanism 12 together will reduce the amount of metals and plastics necessary to produce a fastening mechanism 12. The system and process of the present invention further produces a fastening mechanism 12 for releasably securing a strap and fastening mechanism 12 together will reduce operation cost by at least two-thirds when using identical male/female fastening mechanisms 12.

Using the injection tool 10 of the system and process of the present invention will attain the following benefits in the manufacture of male/female fastening mechanisms 12:

1) Tools will be easier to adjust to the demand of the market;

2) Tools will become more cost effective;

3) Tools will not be shelved;

4) Less storage room will be needed to store tools;

5) Reduces tooling up to approximately 65% depending on design possibilities;

6) Lowers cost of research and development;

7) Any mistakes will be less costly;

8) Reduces machining time on tooling;

9) Reduces the amount of metal alloys used for the injection molding tools up to and approximately 65% depending on the design possibilities;

10) Environmentally green;

11) Reduces cost of the human resource;

12) Reduces time leads to lowering the possibility of injury to employees or contractors;

13) Lowers development and operations cost thus increasing profits; and

14) Ability to vary design to enhance new and existing products.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. An injection molding system for producing a fastening mechanism having a connecting element and an attachment portion, the injection molding system comprising:
an injection molding tool;
at least one cavity formed in the injection molding tool for molding a male/female connecting element;
at least one void formed in the injection molding tool for receiving an insert for molding the attachment portion, the insert aligned with the cavity of the male/female connecting element, the combined male/female connecting element and attachment portion forming the fastening mechanism;
means for releasably securing the insert within the void;
wherein the insert is interchangeable with other inserts allowing various attachment portions for the male/female connecting element.

2. The injection molding system of claim 1 and further comprising two cavities.

3. The injection molding system of claim 2 wherein each cavity is identical to each other cavity.

4. The injection molding system of claim 1 wherein the injection molding tool is constructed from a metal material.

5. The injection molding system of claim 1 and further comprising:
a molding material receivable within each cavity and void.

6. The injection molding system of claim 5 wherein the molding material is a plastic material.

7. A method for constructing a first fastening mechanism, the first fastening mechanism having a connecting element and an attachment portion, the method comprising:
providing an injection molding tool;
forming a first cavity in the injection molding tool for molding the first connecting element;
forming a first void in the injection molding tool adjacent the first cavity for receiving a first insert for molding the first attachment portion, the first insert aligned with the first cavity;
releasably securing the first insert within the first void;
injecting a molding substance into the injection molding tool.

8. The method of claim 7 wherein the molding substance is a plastic material.

9. The method of claim 7 and further comprising:
forming a second cavity in the injection molding tool for molding a second connecting element, the second connecting element identical to the first connecting element;
forming a second void in the injection molding tool adjacent the second cavity for receiving a second insert for molding the second attachment portion, the second insert aligned with the second cavity; and
releasably securing the second insert within the second void

10. A tool for forming a fastening mechanism, each fastening mechanism having both a male portion and a female portion for mating with another identical fastening mechanism, each fastening mechanism further having an attachment portion, the tool comprising:
a molding plate;
a first voided area formed in the molding plate, the first voided area being configured to the shape of the fastening mechanism;
a first cavity formed in the molding plate adjacent the first voided area; and
a first insert releasably securable within the first cavity, the first insert being configured to the shape of the attachment portion.

11. The tool of claim 10 and further comprising:
a second voided area formed in the molding plate, the second voided area being configured to the shape of the fastening mechanism;
a second cavity formed in the molding plate adjacent the second voided area; and
a second insert releasably securable within the first cavity, the second insert being configured to the shape of the attachment portion.

12. The tool of claim 10 wherein the first insert is selected from a group of inserts having different attachment portion configurations.

13. The tool of claim 10 wherein the molding plate is constructed from a metal material.

14. The tool of claim 10 and further comprising:
a molding material receivable within each cavity and voided area.
